(19) United States
(12) Patent Application Publication
(10) Pub. No.: US 2012/0186748 A1
(43) Pub. Date: Jul. 26, 2012

(54) BEADS MODEL PRODUCING BOARD

(75) Inventor: Kei Kamiyama, Tokyo (JP)

(73) Assignee: EPOCH COMPANY LTD., Tokyo (JP)

(21) Appl. No.: 13/351,791

(22) Filed: Jan. 17, 2012

(30) Foreign Application Priority Data
Jan. 21, 2011 (JP) 2011-011112

(51) Int. Cl. B32B 37/04

(52) U.S. Cl. 156/349

(57) ABSTRACT

There is provided a beads model producing board for easily producing a beads model by submerging all beads in water uniformly so that surfaces of the beads are melted and bonded together, comprising a base board member 2 including a liquid reservoir portion 26 therein, a liquid tank 3 including liquid outlet ports 36 communicating with the liquid reservoir portion 26, a filling tank 4 disposed rotatably in the liquid tank 3, a beads placing plate 5 and a beads placing plate holding device 6, wherein after beads are arranged on the beads placing plate 5, the filling tank 4 is rotated to cause liquid to flow into the liquid tank 3, whereby the liquid flows into the liquid reservoir portion 26 to submerge the beads in the liquid, and thereafter, the beads can be dried by erecting the beads placing plate holding device 6 in a self-supporting fashion.

### CROSS-REFERENCE TO RELATED APPLICATION

This application is based upon and claims the benefit of priority under 35 USC 119 of Japanese Patent Application No. 2011-11112 filed on Jan. 21, 2011, the entire contents of which are incorporated herein by reference.

### BACKGROUND OF THE INVENTION

1. Field of the Invention

The present invention relates to a beads model producing board which is used to produce a beads model by melting beads which are in contact with one another by liquid and then bonding them together.

2. Description of the Related Art

There is a beads toy which produces a beads model by melting surfaces of beads which are in contact with one another by liquid and bonding them together. In this beads toy, a plurality of beads are arranged into a predetermined shape such as the shape of a flower or animal such a state that adjacent beads are in contact with one another. Then, in this state, liquid is sprayed to the beads individually so that the beads are wetted once. Thereafter, the beads wetted are dried, and a beads model having the predetermined shape is produced.

Then, in order to facilitate the producing of a beads model using a beads toy like the one described above, the applicant of this patent application proposed a beads pattern producing board in Japanese Unexamined Patent Application No. 2009-5780 (Patent Literature 1). In this proposal, beads are arranged into a predetermined shape on a beads holding tray in such a manner that adjacent beads are in contact with one another. Then, liquid is sprayed or applied to the beads by a spray or a brush. Thereafter, the beads holding tray is erected to lean back in a tray stand in such a state that the beads are kept arranged on the beads holding tray so that the beads in contact with one another are bonded together while being dried. Thereafter, when the beads are dried, the beads which are bonded together are removed from the beads tray, thereby making it possible to produce a beads model easily.

According to the beads pattern producing board in Patent Literature 1, a plurality of depressions are provided on the beads holding tray so that adjacent beads come into contact with one another. Then, by arranging beads into a predetermined shape on this beads holding tray, the beads which are once disposed in predetermined positions on the beads holding tray can be prevented from rolling out of the predetermined positions. In addition, the beads can easily be wetted with liquid on the beads holding tray. Additionally, by providing the tray stand, the beads holding tray can be leaned back in the tray stand with the beads kept arranged into the predetermined shape on the beads holding tray, and this facilitates the drying of the wet beads.

### BRIEF SUMMARY OF THE INVENTION

In the beads pattern producing board described in Patent Literature 1 above or other assisting devices for producing a beads model, the adjacent beads are only arranged into the predetermined shape while kept in contact with one another, and therefore, the spray or brush needs to be used to wet the beads. Consequently, it has been difficult to wet all the beads which are arranged on the tray so as to produce the beads model uniformly with the liquid.

The invention has been made in view of the problem described above, and an object thereof is to provide a beads model producing board in which when producing a beads model, all beads which are arranged to be in contact with one another can be wetted evenly and uniformly with liquid so as to facilitate the producing of the beads model.

With a view to attaining the object, according to a first aspect of the invention, there is provided a beads model producing board for use in a beads toy for producing a beads model by melting beads which are in contact with one another with liquid and bonding them together, comprising: a base board member which includes a liquid reservoir portion in an inside thereof; a liquid tank which is mounted on the base board member and which includes a liquid outlet port which communicates with the liquid reservoir portion; and a beads placing plate on which beads are placed, wherein the beads placing plate is disposed in the liquid reservoir portion in the base board member, and by filling the liquid tank with liquid, the liquid flows out of the liquid tank into the liquid reservoir portion to thereby submerge the beads on the beads placing plate in the liquid.

According to a second aspect of the invention, there is provided a beads model producing board as set forth in the first aspect of the invention, comprising: a filling tank which is rotatably disposed in the liquid tank, wherein by rotating the filling tank with liquid filled therein, the liquid flows out of the filling tank into the liquid tank to thereby fill the liquid tank with the liquid.

According to a third aspect of the invention, there is provided a beads model producing board as set forth in the first aspect of the invention, comprising: a beads placing plate holding device which is adapted to hold the beads placing plate and which is rotatably mounted on the base board member so as to hold the beads placing plate in a state in which the beads placing plate is accommodated within the liquid reservoir portion in the base board member and a state in which the beads placing plate is rotated to be erected from the base board member.

According to a fourth aspect of the invention, there is provided a beads model producing board as set forth in the second aspect of the invention, wherein the filling tank is detachably mounted in the liquid tank.

According to a fifth aspect of the invention, there is provided a beads model producing board as set forth in the second aspect of the invention, wherein the filling tank is a substantially semicircular container comprising two substantially semicircular plates which are disposed parallel to each other and an arc-shaped face plate which connects together arcs of the two substantially semicircular plates, and wherein rotating shafts which project outwards are provided in the vicinity of centers of the two semicircular plates and the filling tank is rotatably mounted in the liquid tank by the rotating shafts being brought into engagement with the liquid tank.

According to a sixth aspect of the invention, there is provided a beads model producing board as set forth in the fifth aspect of the invention, wherein the filling tank has a self-supporting projection which is provided in the vicinity of a central portion of the arc-shaped face plate so as to constitute a stand for the filling tank when the filling tank is refilled with liquid.

According to a seventh aspect of the invention, there is provided a beads model producing board as set forth in the fifth aspect of the invention, wherein a plurality of straightening vanes are formed inside the filling tank so as to straighten a flow of liquid when liquid within the filling tank is caused to flow into the liquid tank, and wherein the plurality of straightening vanes are provided to be erected from the arc-shaped face plate so as to be parallel to a straight line which connects a center of the arc-shaped face plate and centers of the arcs and vertical to the two substantially semicircular plates and each have a U-shaped cutout in an upper end member portion thereof, at least one of the plurality of straightening vanes constituting an indicator of the amount of liquid poured in the filling tank when the filling tank is refilled with liquid.

According to an eighth aspect of the invention, there is provided a beads model producing board as set forth in the third aspect of the invention, wherein the base board member comprises the liquid reservoir portion which is depressed into a substantially rectangular shape and a tank disposing portion which is situated behind the liquid reservoir portion and where the liquid tank is disposed and includes bearing portions which each have two grooves of a front groove and a rear groove which hold rotatably the beads placing plate holding device, the bearing portions being formed on left and right side walls which make up the liquid reservoir portion and the tank disposing portion in left and right symmetrical positions which lie in the vicinity of front ends of the left and right side walls, and wherein the beads placing plate holding device comprises a front wall, left and right side walls and a lower plate and includes engagement portions which each have two projections of a front shaft and a rear shaft which are brought into engagement with the front groove and the rear groove of the base board member, respectively, the engagement portions being formed on the left and right side walls in left and right symmetrical positions which lie in the vicinity of front ends of the left and right side walls, whereby the beads placing plate holding device is put in a state in which the beads placing plate holding device is disposed flat in the liquid reservoir portion in the base board member by disposing the lower plate close to a bottom portion of the liquid reservoir portion from thereabove, while the beads placing plate holding device is put in a state in which the beads placing plate holding device stands on the base board member in a self-supporting fashion by inserting the front shaft and the rear shaft into the front groove.

According to a ninth aspect of the invention, there is provided a beads model producing board as set forth in the eighth aspect of the invention, wherein the front grooves of the base board member are a groove which rises vertically from a lower portion of the base board member, wherein the rear grooves of the base board member are a groove comprising an arc portion which extends downwardly rearwards from the vicinity of an upper end of the front groove and a vertical portion which rises vertically from a lower portion of the base board member at the rear of the arc portion, and wherein a center of a radius of curvature of the arc portion of the rear groove is situated further upwards than a lower end of the front groove.

According to a tenth aspect of the invention, there is provided a beads model producing board as set forth in the third aspect of the invention, wherein the base board member, the beads placing plate and the beads placing plate holding device are all formed of a resin having light transmitting characteristics.

According to an eleventh aspect of the invention, there is provided a beads model producing board as set forth in the first aspect of the invention, comprising a sample picture placing plate on which a sample picture which constitutes a sample of a beads model to be produced is placed and which can be inserted into a lower portion of the base board member.

According to the aspects of the invention, the beads model producing board can be provided in which when producing a beads model, all the beads which are arranged on the beads placing plate can be wetted evenly and uniformly with liquid so as to enable the beads which are in contact with one another to be bonded together to thereby facilitate the producing of the beads model.

### BRIEF DESCRIPTION OF THE SEVERAL VIEWS OF THE DRAWINGS

FIG. 1 is a perspective view of a beads model producing board according to an embodiment of the invention.

FIG. 2 is a perspective view of the beads model producing board with a filling tank rotated.

FIG. 3 is an exploded perspective view of the beads model producing board.

FIG. 4 is a side view of the beads model producing board.

FIGS. 5 (a) and (b) show enlarged exemplary diagrams of a bearing portion of a base board member and an engagement portion of a beads placing plate holding device.

FIGS. 6 (a), (b) and (c) show explanatory diagrams depicting the operation of the base board member and the beads placing plate holding device.

FIGS. 7 (a) and (b) show explanatory diagrams depicting how to use the beads model producing board.

FIGS. 8 (a) and (b) show explanatory diagrams depicting how to use the beads model producing board.

FIGS. 9 (a) and (b) show explanatory diagrams depicting how to use the beads model producing board.

### DETAILED DESCRIPTION OF THE PREFERRED EMBODIMENT

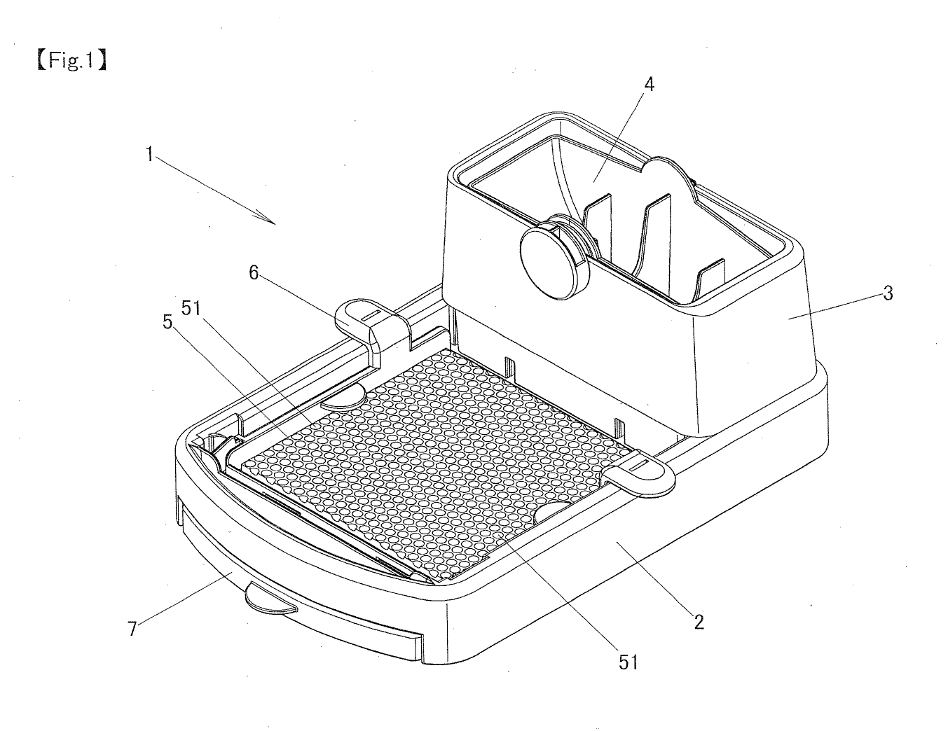

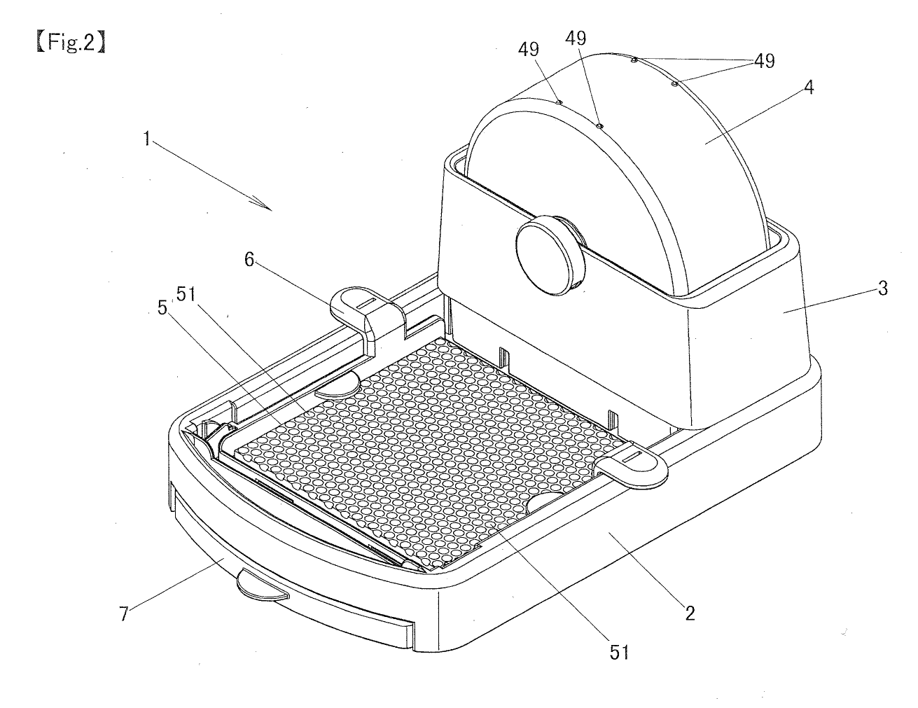

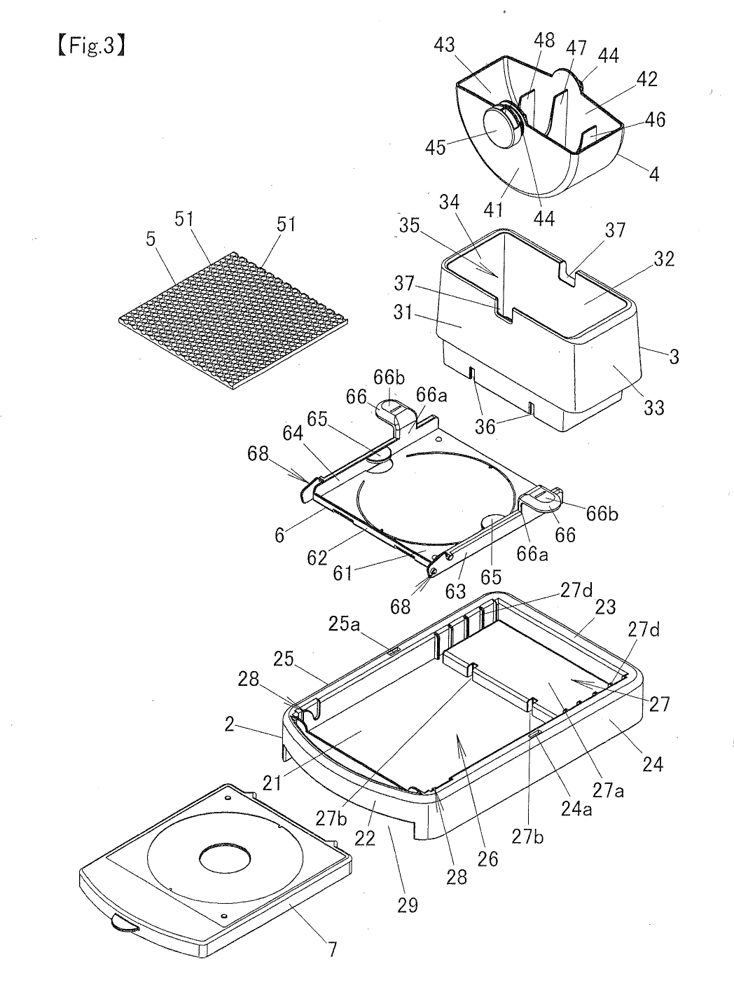

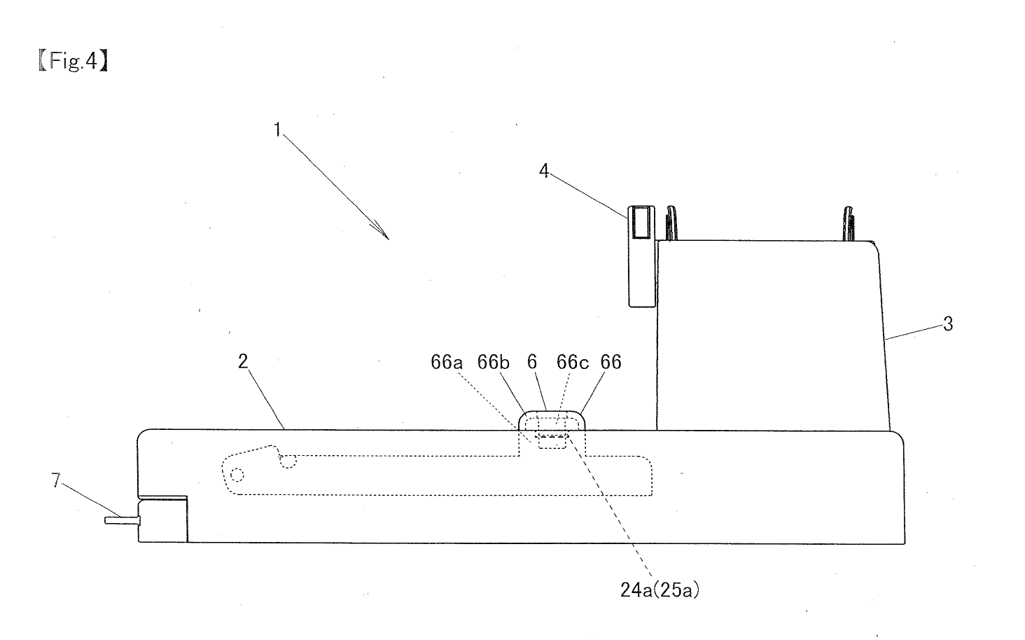

Hereinafter, an embodiment of the invention will be described. FIG. 1 is a perspective view of a beads model producing board according to an embodiment of the invention. FIG. 2 is a perspective view of the beads model producing board with a filling tank rotated. FIG. 3 is an exploded perspective view of the beads model producing board. FIG. 4 is a side view of the beads model producing board with an interior seen therethrough. The following description will be made on the understanding that in FIG. 1, a side where a liquid tank 3 is disposed is referred to as rear, a side which is opposite to the liquid tank 3 and where a sample picture placing plate 7 is disposed is referred to as front, a direction which is at right angles to a front-to-rear direction and is parallel to a base board member 2 is referred to as a left-to-right direction (a transverse direction), and a direction which is at right angles to the front-to-rear and left-to-right directions is referred to as a top-to-bottom or vertical direction.

A beads model producing board 1 according to this embodiment is a device for producing a beads model such as an accessory having the shape of a flower, animal or the like by combining together beads which can be melted and bonded together with water. Beads models can easily be produced by this beads model producing board. In addition, this beads model producing board enables all beads to be submerged uniformly and the beads model submerged in water to easily be dried. Hereinafter, the beads model producing board 1 will be described in detail by reference to the drawings.

As shown in FIGS. 1 and 2, the beads model producing board 1 includes a base board member 2 which has a thick flat plate-like shape and constitutes a base of the beads model producing board 1, a liquid tank 3 which is disposed at the rear of the base board member 2 so as to supply liquid to the base board member 2, a filling tank 4 which is mounted rotatably in the liquid tank 3 so as to supply liquid to the liquid tank 3, a beads placing plate 5 on which beads are arranged, a beads placing plate holding device 6 which is adapted to hold the beads placing plate 5 inside and at the front of the base board member 2, and a sample picture placing plate 7 which is disposed in a lower portion of the base board member 2 so as to be pulled thereout.

As shown in FIGS. 1 to 3, the base board member 2 includes an intermediate plate 21 which has a substantially rectangular shape although a front end member is curved and occupies substantially the whole of the base board member 2, a front wall 22 which is formed vertical along the front end member of the intermediate plate 21, a rear wall 23 which is formed vertical along a rear end side of the intermediate plate 21, left- and right-hand side walls 24, 25 which are formed vertical along left- and right-hand lateral edge members of the intermediate plate 21. The base board member 2 is formed of a (transparent) resin having light transmitting characteristics. The base board member 2 has a depression configured as a liquid reservoir portion 26 on a front side which is surrounded by the intermediate plate 21 and the front, rear and left- and right-hand side walls 22, 23, 24, 25 and a tank disposing portion 27 on a rear side thereof. A tapered inclined portion is formed at a connecting portion between the front wall 22 and the intermediate plate 21.

The front, rear and left- and right-hand side walls 22, 23, 24, 25 are each formed by an inner wall and an outer wall with a space interposed therebetween. Bearing portions 28 are formed in the vicinity of front ends of inner walls of the left-hand side wall 24 and the right-hand side wall 25, respectively. The beads placing plate holding device 6 is rotatably brought into engagement with the bearing portions 28. This bearing portion 28 will be described in detail later. In addition, a cutout is formed in the front wall 22 so as to expand in a height direction from a lower end of a central portion of the front wall 22 to a position lying on an extension of a lower surface of the intermediate plate 21. The cutout also expands substantially along the full width of the base board member 2. By forming the cutout in this way, the sample picture placing plate 7 can be inserted into and pulled out of a placing plate accommodation portion 29 formed in a position lying below the intermediate plate 21 from the front.

A rectangular parallelepiped protuberant portion 27a is formed at the tank disposing portion 27 of the base board member 2 so as to project upwards from the intermediate plate 21. The liquid tank 3 is fitted on this protuberant portion 27a. In addition, two liquid outlet grooves 27b are formed in a front end face of the protuberant portion 27a. These liquid outlet grooves 27b come to coincide in position with liquid outlet ports 36 formed in the liquid tank 3, which will be described later, when the liquid tank 3 is fitted on the protuberant portion 27a. Further, pluralities of engagement projections 27d are formed on portions of the left- and right-hand side walls 24, 25 of the base board member 2 which face the tank disposing portion 27. These engagement projections 27d are brought into engagement with external surfaces of the liquid tank 3. Locking holes 24a, 25a are formed in substantially central portions in the front-to-rear direction of upper surfaces of the left- and right-hand side walls 24, 25 of the base board member 2. Locking projections formed on the beads placing plate holding device 6, which will be described later, are locked in the locking holes 24a, 25a.

The liquid tank 3 is a member which is made up of a front wall 31, a rear wall 32 and side walls 33, 34 and is opened at a top and a bottom thereof. Then, when the liquid tank 3 is fitted on the protuberant portion 27a at the tank disposing portion 27 of the base board member 2 at the bottom thereof, a liquid accommodation portion 35 is defined inside the liquid tank 3 with the protuberant portion 27a functioning as a bottom thereof. In addition, the liquid outlet ports 36 are formed in a lower end of the front wall 31 of the liquid tank 3 in positions which coincide with the liquid outlet grooves 27b formed in the base board member 2. By forming the liquid outlet ports 36, the liquid accommodation portion 35 and the liquid reservoir portion 26 in the base board member 2 are allowed to communicate with each other when the liquid tank 3 is fitted on the protuberant portion 27a at the tank disposing portion 27 of the base board member 2. Therefore, liquid inside the liquid tank 3 is allowed to flow out into the liquid reservoir portion 26 in the base board member 2 via the liquid outlet grooves 27 and the liquid outlet ports 36. Further, cutouts 37 are provided in central portions of upper end members of the front wall 31 and the rear wall 32 of the liquid tank 3, respectively. Rotating shafts 44 of the filling tank 4, which will be described later, are pivotally supported in the cutouts 37.

The filling tank 4 is a member which can be rotated within the liquid tank 3 between a state in which the filling tank 4 is allowed to be held within the liquid tank 3 with the filling tank 4 filled with liquid (FIG. 1) and a state in which the liquid within the filling tank 4 allowed to flow out into the liquid tank 3 (FIG. 2). This filling tank 4 is a substantially semicircular container which includes a front wall 41 and a rear wall 42 which are two plates having a substantially semicircular shape (substantially semicircular plates) and an arc-shaped end face 43 which connects together arc portions of the front wall 41 and the rear wall 42. The rotating shafts 44 are formed at central portions of the filling tank 4 (at central portions of the arcs of the front wall 41 and the rear wall 42) so as to project outwards in the front-to-rear direction. A knob 45 is formed at a front end of the rotating shaft 44 on the front wall 41. This filling tank 4 can be mounted in the liquid tank 3 so that the rotating shafts 44 are pivotally supported in the cutouts 37 in the liquid tank 3. When the knob 45 is rotated, liquid contained in the filling tank 4 can be shifted into an interior of the liquid tank 3.

Additionally, three straightening vanes 46, 47, 48 are formed inside the filling tank 4 so as to straighten a flow of liquid when liquid contained in the filling tank 4 is allowed to flow thereout into the liquid tank 3. The three straightening vanes 46, 47, 48 are formed to be erected from the arc-shaped face plate 43 parallel to a straight line which connects a center of the arc-shaped face plate 43 with centers of the arcs of the front and rear walls 41, 42 and vertical to the front wall 41 and the rear wall 42. The three straightening vanes 46, 47, 48 each have a U-shaped cutout in an upper end member thereof. The central straightening vane 47 is formed taller than the other straightening vanes 46, 48 (to project further towards the open side of the filling tank 4), and an upper end of the straightening vane 47 constitutes an indicator of the amount of liquid poured when the filling tank 4 is filled with liquid.

Further, as shown in FIG. 2, a plurality of projections 49 are formed so as to project outwards on an external surface of the arc-shaped face plate 43 of the filling tank 4 at a portion lying in the vicinity of a lower end (a portion lying in the vicinity of the center of the arc-shaped face plate 43). These projections 49 are self-supporting projections 49 which serve to play a role of stands (legs) when the filling tank 4 is caused to stand in a self-supporting fashion. Namely, by forming the self-supporting projections 49 on the filling tank 4, a liquid pouring operation can be performed with the filling tank 4 standing in the self-supporting fashion when the filling tank 4 is filled with liquid. These self-supporting projections 49 project in such an amount that the projections 49 do not physically interfere with the side walls 33, 34 of the liquid tank 3 when the filling tank 4 rotates within the liquid tank 3.

As shown in FIGS. 1 to 3, the beads placing plate 5 has a rectangular shape and is formed of a resin having light transmitting characteristics. A plurality of substantially semispherical depressions 51 are arranged at equal intervals on an upper surface of the beads placing plate 5. Beads are disposed in these depressions 51. These depressions 51 are formed so that when beads are placed therein, adjacent beads come into contact with one another.

The beads placing plate holding device 6 is a holding device which is formed of a resin having light transmitting characteristics and which can be rotated relative to the base board member 2 with the beads placing plate 5 held thereon. The beads placing plate holding device 6 is adapted to be held on the base board member 2 in a state in which the beads placing plate holding device 6 is disposed flat or horizontal in the liquid reservoir portion 26 in the base board member 2 and a state in which the beads placing plate holding device 6 stands on the base board member 2 in the self-supporting fashion.

This beads placing plate holding device 6 is made up of a rectangular lower plate 61, a front wall 62 which is erected from a front end member of the lower plate 61, and side walls 63, 64 which are erected from lateral edge members of the lower plate 61. The front wall 62 is formed lower than the side walls 63, 64. Front ends of the side walls 63, 64 are formed so as to project further forwards than the front wall 62. In addition, locking plates 65, 65 are formed in the vicinity of centers of the side walls 63, 64 in the front-to-rear direction so as to project transversely inwards to thereby lock the beads placing plate 5.

Grip portions 66 are formed to lie above positions in the vicinity of rear ends of the side walls 63, 64. These grip portions 66 are portions to be gripped on when raising the beads placing plate holding device 6 from the base board member 2. These grip portions 66 include upwardly extending portions 66a which extend upwards from the side walls 63, 64 and sideways extending portions 66b which extend transversely outwards from upper ends of the upwardly extending portions 66a. In addition, locking projections 66c are formed on lower surfaces of the sideways extending portions 66b as shown in FIG. 4. These locking projections 66c are locked in the locking holes 24a, 25a which are formed in the left- and right-hand side walls 24, 25 of the base board member 2. Consequently, by allowing the locking projections 66c to be locked in the locking holes 24a, 25a when the beads placing plate holding device 6 is laid on the base board member 2, the beads placing plate holding device 6 is fixed to the base board member 2, whereby the beads placing plate holding device 6 is prevented from being moved in the midst of a beads placing operation (while beads are being arranged on the beads placing plate 5) by the user.

In addition, engagement portions 68 are formed at front end portions of the side walls 63, 64 of the beads placing plate holding device 6 as shown in FIG. 3. These engagement portions 68 are brought into engagement with the bearing portions 28 of the base board member 2. Depending upon the engaged state of the engagement portions 68 with the bearing portions 28 of the base board member 2, the beads placing plate holding device 6 can be change in position so as to be held in the state in which the beads placing plate holding device 6 is disposed flat on the base board member 2 and in the state in which the beads placing plate holding device 6 stands on the base board member 2 in the self-supporting fashion as has been described above. Hereinafter, the configurations of the bearing portions 28 of the base board member 2 and the engagement portions 68 of the beads placing plate holding device 6 will be described in detail.

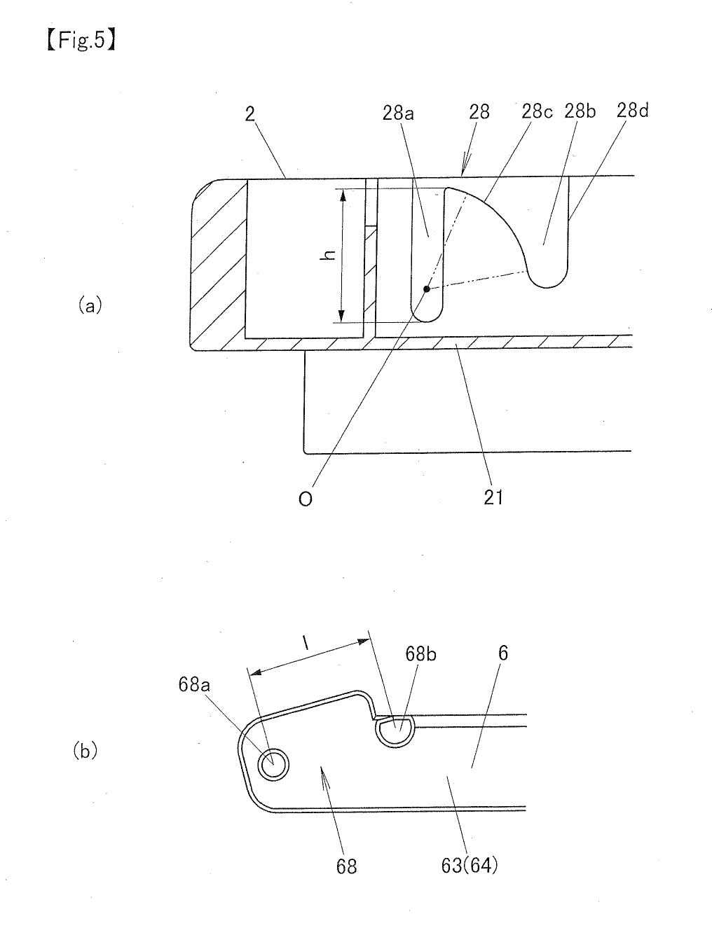

As shown in FIG. 5(a), the bearing portion 28 of the base board member 2 includes two grooves of a front groove 28a and a rear groove 28b. The front groove 28a is a substantially U-shaped groove which is formed vertical to the intermediate plate 21 of the base board member 2. The rear groove 28b includes an arc portion 28c which extends downwardly rearwards from the vicinity of an upper end of the front groove and a vertical portion 28b which is formed vertical to the intermediate plate 21 of the base board member 2 at the rear of the arc portion 28c. In addition, a center O of a radius of curvature which makes up the arc portion 28c is situated further upwards than a lower end of the front groove 28a. The center O shown in FIG. 5(a) an imaginary point for the purpose of illustration and is not a point which exists in reality.

As shown in FIG. 5(b), the engagement portion 68 of the beads placing plate holding device 6 includes two projections of a front shaft 68a and a rear shaft 68b which project transversely outwards from each of the side walls 63, 64. The front shaft 68a is formed in the vicinity of the front end of each of the side walls 63, 64, and the rear shaft 68b is formed in a position which is situated further rearwards and further upwards than the front shaft 68a. In addition, a distance 1 between the front groove 68a and the rear groove 68b is substantially the same as a distance between lower ends of the front groove 28a and the rear groove 28b in the base board member 2. Namely, the center O of the radius of curvature of the arc portion 28c of the rear groove 28b in the base board member 2 is situated further upwards than the lower end of the front groove 28a, and the distance 1 between the front shaft 68a and the rear shaft 68b on the beads placing plate holding device 6 is substantially the same as the distance between the lower ends of the front groove 28a and the rear groove 28b in the base board member 2. Therefore, a depth h of the front groove 28a in the base board member 2 is formed slightly deeper or larger than the distance between the front shaft 68a and the rear shaft 68b on the beads placing plate holding device 6 (h>1).

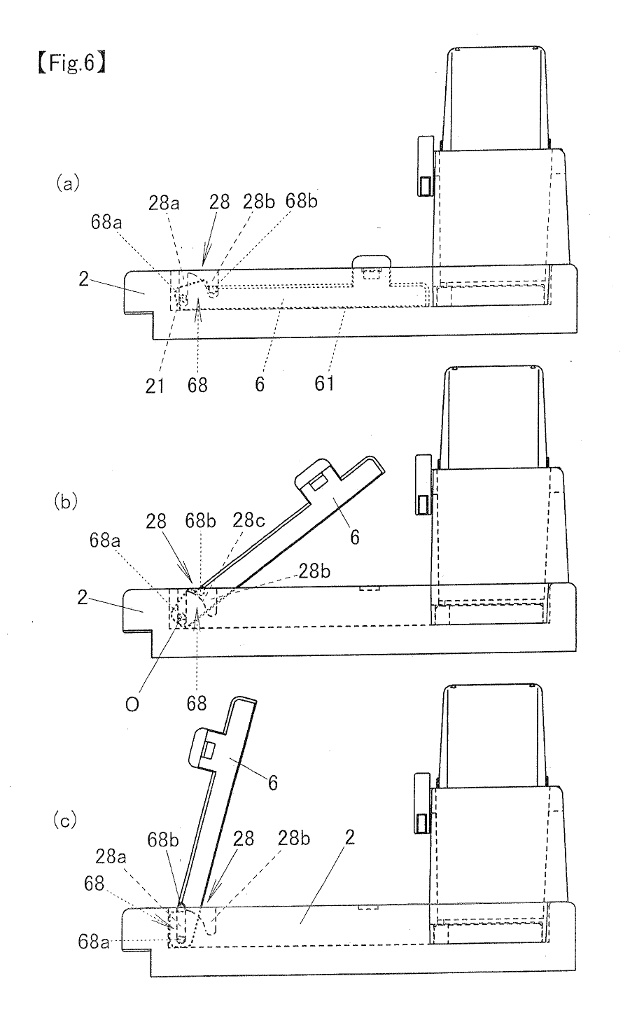

Next, the operation of the beads placing plate holding device 6 will be described. When the beads placing plate holding device 6 is laid flat, that is, when the lower plate 61 of the beads placing plate holding device 6 becomes parallel and is disposed close to the intermediate plate 21 of the base board member 2, as shown in FIG. 6(a), the lower plate 61 of the beads placing plate holding device 6 comes first into contact with the intermediate plate 21 of the base board member 2. Therefore, the front shaft 68a and the rear shaft 68b of the beads placing plate holding device 6 are positioned so as to be slightly above the lower end of the front groove 28a and the lower end of the rear groove 28b in the base board member 2, respectively.

When the beads placing plate holding device 6 is raised from the state in which the beads placing plate holding device 6 is laid flat, as shown in FIG. 6(b), the rear shaft 68b of the beads placing plate holding device 6 makes a circular motion while being guided by the arc portion 28c of the rear groove 28b in the base board member 2, and the front shaft 68a of the beads placing plate holding device 6 is positioned in the center O of radius curvature of the arc portion 28c of the rear groove 28b in the base board member 2.

When the beads placing plate holding device 6 is raised completely, as shown in FIG. 6(c), the front shaft 68a and the rear shaft 68b of the beads placing plate holding device 6 fall in the front groove 28a in the base board member 2, and the front shaft 68a comes into contact with the lower end of the front groove 28a, while the rear shaft 68b of the beads placing plate holding device 6 comes into contact with a rear end wall of the front groove 28a which is situated at an upper end thereof. Namely, the beads placing plate holding device 6 is allowed to stand in the self-supporting fashion by the front shaft 68a and the rear shaft 68b of the beads placing plate holding device 6 being brought into engagement with the front groove 28a.

The sample picture placing plate 7 is a substantially rectangular plate of which a front end face is curved to the front and can be inserted into the placing plate accommodation portion 29 with a sample picture placed on an upper surface thereof. In such a state that the sample picture placing plate 7 is inserted in the base board member 2, since the base board member 2, the beads placing plate holding device 6 and the beads placing plate 5 are all made of the resin having the light transmitting characteristics (the transparent resin), the sample picture can be visualized from above the beads model producing board 1.

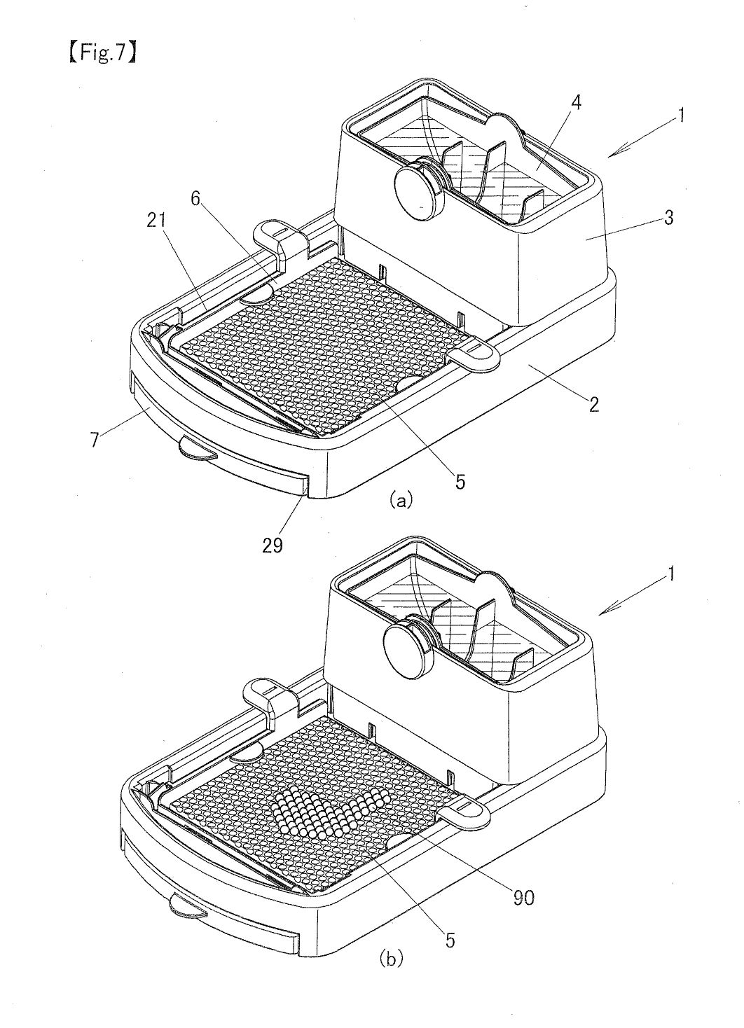

Next, how to use the beads model producing board configured as has been described heretofore will be described. Firstly, to prepare a state resulting before beads are arranged on the beads placing plate 5 (prior to the start of a beads arranging operation) as shown in FIG. 7(a), as a preparation, a sample picture is placed on the sample picture placing plate 7, and the sample picture placing plate 7 is inserted into the placing plate accommodation portion 29. Then, the beads placing plate 5 is set on the beads placing plate holding device 6 in such a state that the beads placing plate holding device 6 is raised. Thereafter, the beads placing plate holding device 6 is laid flat on the intermediate plate 21, and the locking projections 66c on the beads placing plate holding device 6 are locked in the locking holes 24a, 25a in the base board member 2 shown in FIG. 4. Further, liquid is poured into the filling tank 4 until the level of liquid therein is raised substantially as high as the upper end of the straightening vane 47 which is situated in the middle of the straightening vanes. Then, the filling tank 4 is loaded in the liquid tank 3 while trying to prevent the overflow of liquid from the filling tank 4. In this state, beads 90 are arranged on the beads placing plate 5 so as to follow the sample picture as shown in FIG. 7(b). Note that the order in which the preparatory operations are performed is not limited to the order described above.

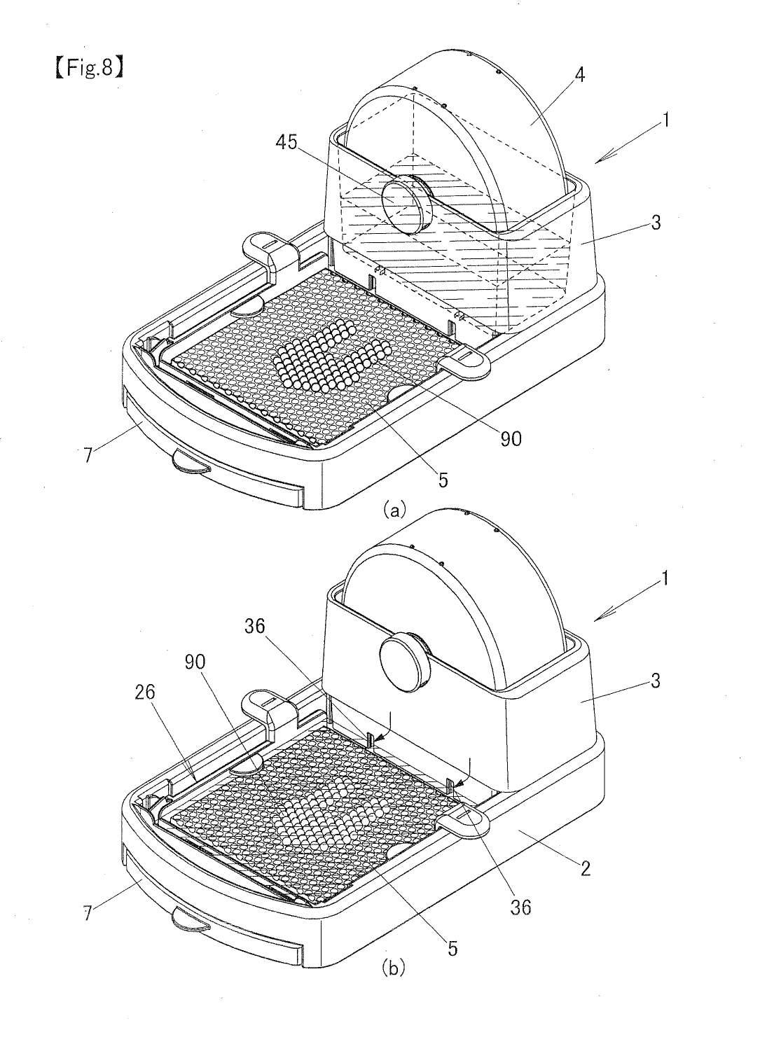

After the beads 90 have been arranged on the beads placing plate 5, as shown in FIG. 8(a), the knob 45 of the filling tank 4 is gripped on by fingers to rotate the filling tank 4 half a rotation so that liquid contained in the filling tank 4 is caused to flow into the liquid tank 3. When the liquid flows into the liquid tank 3, as shown in FIG. 8(b), the liquid flows into the liquid reservoir portion 26 in the base board member 2 from the liquid outlet port 36 in the liquid tank 3, whereby the beads 90 on the beads placing plate 5 are submerged in the liquid. As this occurs, the liquid within the liquid tank 3 is allowed to flow bit by bit into the liquid reservoir portion 26 in the base board member 2 from the liquid outlet ports 36. Therefore, there is no such situation that the beads 90 arranged on the beads placing plate 5 are shifted from predetermined positions on the beads placing plate 5. In addition, the amount of liquid poured into the filling tank 4 so as to match the height of the straightening vane 47 is such that the beads placing plate 5 fixedly placed in the liquid reservoir portion 26 in the base board member 2 and the beads 90 arranged on the beads placing plate 5 are submerged completely in the liquid while the liquid is being prevented from overflowing from the liquid reservoir portion 26.

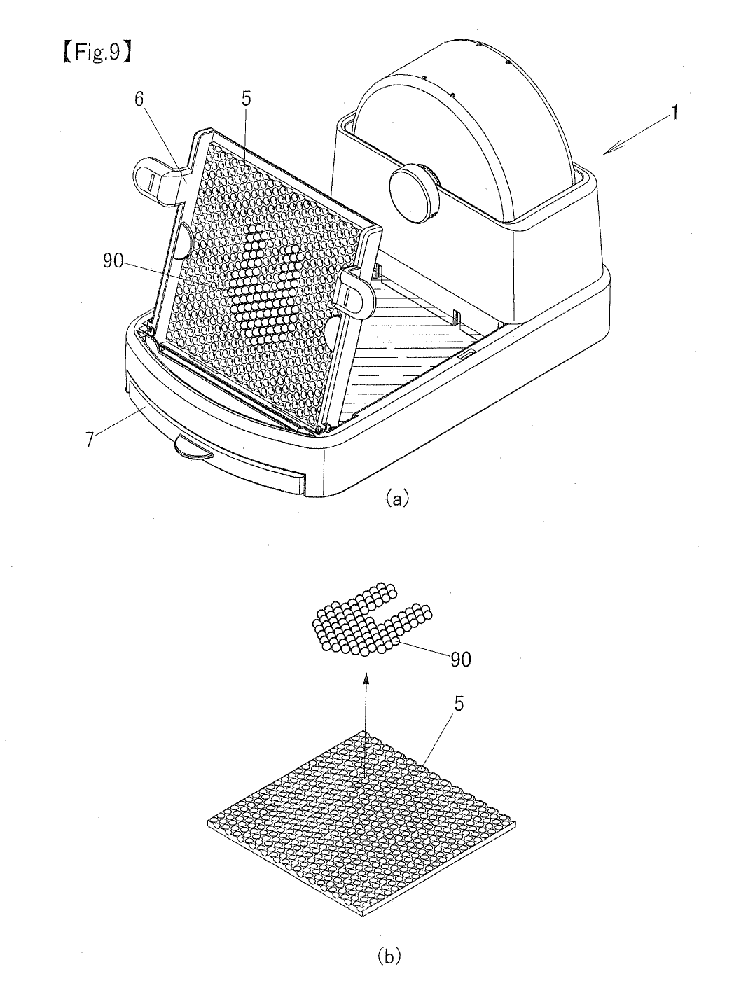

Then, when the beads placing plate holding device 6 is raised after a predetermined length of time has elapsed, the liquid within the beads placing plate 5 (or the beads placing plate holding device 6) flows into the liquid reservoir portion 26 in the base board member 2. Then, as shown in FIG. 9(a), by leaving the beads placing plate holding device 6 in the self-supporting state for a predetermined period of time, the beads 90 can be dried. After the beads 90 have been dried, the beads placing plate 5 is removed from the beads placing plate holding device 6. Then, as shown in FIG. 9(b), a resulting model of the beads 90 is removed from the beads placing plate 5, whereby the model of the beads 90 is completed.

A configuration may be adopted in which the filling tank 4 is not filled with liquid in the preparatory stage but is filled with liquid after beads 90 have been arranged on the beads placing plate 5. In addition, the sample picture placing plate 7 becomes unnecessary after beads 90 have been arranged on the beads placing plate 5, and therefore, the sample picture placing plate 7 may be removed from the base board member 2 before the beads placing plate 5 is submerged completely in liquid. Namely, only one example of a way to use the beads model producing board 1 has been described by taking the aforesaid way to use the beads model producing board 1 as an example, and therefore, the beads model producing board can be used in a way desired by the user.

In this way, the beads model producing board 1 according to the embodiment includes the base board member 2 which has the liquid reservoir portion 26 disposed in the inside thereof, the liquid tank 3 which is mounted on the base board member 2 and which has the liquid outlet ports 36 which communicate with the liquid reservoir portion 26 in the base board member 2, and the beads placing plate 5 on which beads 90 are placed. Then, the beads placing plate 5 is disposed in the liquid reservoir portion 26 in the base board member 2, and the liquid tank 3 is filled with liquid. Thus, the beads 90 placed on the beads placing plate 5 can be submerged evenly and uniformly in the liquid from the liquid tank 3. In addition, the liquid contained in the liquid tank 3 is allowed to flow bit by bit into the liquid reservoir portion 26 in the base board member 2 from the liquid outlet ports 36, and therefore, there is caused no such situation that the liquid flows into the liquid reservoir portion 26 from the liquid tank 3 in one breath to thereby carry away the beads 90 on the beads placing plate 5 therefrom.

Further, by providing the filling tank 4 which is disposed rotatably in the liquid tank 3, no liquid is allowed to flow into the liquid reservoir portion 26 in the base board member 2 in the midst of performing the operation of arranging beads 90 on the beads placing plate 5. In addition, the beads 90 are allowed to be submerged in liquid by rotating the filling tank 4 when submerging the beads 90 in liquid.

In addition, by providing the beads placing plate holding device 6 which is mounted rotatably in the base board member 2, the beads placing plate 5 can be held in the state in which the beads placing plate 5 is accommodated within the liquid reservoir portion 26 in the base board member 2 (the state in which the beads placing plate 5 is laid flat within the liquid reservoir portion 26 in the base board member 2) and the state in which the beads placing plate 5 rotates to rise from the base board member 2. Consequently, both the operation of arranging beads 90 and the operation of drying beads 90 can easily be performed.

Further, by providing the filling tank 4 which is detachably mounted in the liquid tank 3, the operation of filling the filling tank 4 with water can easily be performed.

Additionally, the filling tank 4 is configured as the container having the semicircular shape. Therefore, the filling tank 4 is allowed to be rotated easily, and when rotated, the filling tank 4 is prevented from the physical interference with the liquid tank 3.

By providing the self-supporting projections 49 on the filling tank 4, the filling tank 4 is allowed to stand in the self-supporting fashion when the filling tank 4 is filled with liquid, and therefore, the filling operation can easily be performed.

By providing the plurality of straightening vanes 46, 47, 48 inside the filling tank 4, the liquid in the filling tank 4 is allowed to be poured smoothly into the liquid tank 3. In addition, the upper end of the straightening vane 47 constitutes the indicator of the amount of liquid poured into the filling tank 4 when the filling tank 4 is refilled. Therefore, it is possible to prevent the occurrence of a risk that liquid is poured so much into the filling tank 4 that an overflow of liquid from the filling tank 4 is triggered or a risk that liquid is poured so little into the filling tank 4 that the beads 90 on the beads placing plate 5 cannot be submerged in liquid.

In addition, the front grooves 28a and the rear grooves 28b are provided in the base board member 2 as the bearing portions 28, and the front shafts 68a and the rear shafts 68b are provided on the beads placing plate holding device 6 as the engagement portions 68. Thus, depending upon the engaged state of the grooves 28a, 28b with the shafts 68a, 68b, the beads placing plate 5 can be held in the state in which the beads placing plate 5 is laid flat in the base board member 2 and the state in which the beads placing plate 5 stands in the self-supporting fashion on the base board member 2.

Further, due to the center O of the radius of curvature of the arc portion 28c of the rear groove 28b in the base board member 2 being situated further upwards than the lower end of the front groove 28a, the depth h of the front groove 28a is slightly deeper or larger than the distance 1 between the front shaft 68a and the rear shaft 68b on the beads placing plate holding device 6. Because of this, when the beads placing plate holding device 6 is raised, the front shafts 68a and the rear shafts 68b on the beads placing plate holding device 6 are accommodated in the front grooves 28a in the base board member 2. Therefore, the front shafts 68a and the rear shafts 68b are locked in the front grooves 28a, whereby the beads placing plate holding device 6 can stand in the self-supporting fashion on the base board member 2.

The base board member 2, the beads placing plate 5 and the beads placing plate holding device 6 are all formed of the resin having light transmitting characteristics. Therefore, what lies below the intermediate plate 21 of the base board member 2 can be visualized from above the beads placing plate 5, whereby the operation of arranging beads 90 can be performed while referring to the sample picture on the sample picture placing plate 7.

The invention is not limited to the embodiment that has been described heretofore but can be modified or improved freely without departing from the spirit and scope of the invention. Namely, the object of the invention is to provide the beads model producing board 1 in which when producing a beads model, all beads 90 can be submerged evenly and uniformly in water so as to facilitate the producing of the beads model. Thus, a change in design including a design change or an increase or decrease in the number of constituent members still falls within the scope of the invention or the scope of equivalents as long as such a change does not depart from the object of the invention.

What is claimed is:

1. A beads model producing board for use in a beads toy for producing a beads model by melting beads which are in contact with one another with liquid and bonding them together, comprising:
a base board member which includes a liquid reservoir portion in an inside thereof;
a liquid tank which is mounted on the base board member and which includes a liquid outlet port which communicates with the liquid reservoir portion; and
a beads placing plate on which beads are placed, wherein
the beads placing plate is disposed in the liquid reservoir portion in the base board member, and by filling the liquid tank with liquid, the liquid flows out of the liquid tank into the liquid reservoir portion to thereby submerge the beads on the beads placing plate in the liquid.

2. A beads model producing board as set forth in claim 1, comprising:
a filling tank which is rotatably disposed in the liquid tank, wherein
by rotating the filling tank with liquid filled therein, the liquid flows out of the filling tank into the liquid tank to thereby fill the liquid tank with the liquid.

3. A beads model producing board as set forth in claim 1, comprising:
a beads placing plate holding device which is adapted to hold the beads placing plate and which is rotatably mounted on the base board member so as to hold the beads placing plate in a state in which the beads placing plate is accommodated within the liquid reservoir portion in the base board member and a state in which the beads placing plate is rotated to be erected from the base board member.

4. A beads model producing board as set forth in claim 2, comprising:
a beads placing plate holding device which is adapted to hold the beads placing plate and which is rotatably mounted on the base board member so as to hold the beads placing plate in a state in which the beads placing plate is accommodated within the liquid reservoir portion in the base board member and a state in which the beads placing plate is rotated to be erected from the base board member.

5. A beads model producing board as set forth in claim 2, wherein
the filling tank is detachably mounted in the liquid tank.

6. A beads model producing board as set forth in claim 4, wherein
the filling tank is detachably mounted in the liquid tank.

7. A beads model producing board as set forth in claim 2, wherein
the filling tank is a substantially semicircular container comprising two substantially semicircular plates which are disposed parallel to each other and an arc-shaped face plate which connects together arcs of the two substantially semicircular plates, and wherein
rotating shafts which project outwards are provided in the vicinity of centers of the two semicircular plates, and the filling tank is rotatably mounted in the liquid tank by the rotating shafts being brought into engagement with the liquid tank.

8. A beads model producing board as set forth in claim 4, wherein
the filling tank is a substantially semicircular container comprising two substantially semicircular plates which are disposed parallel to each other and an arc-shaped face plate which connects together arcs of the two substantially semicircular plates, and wherein
rotating shafts which project outwards are provided in the vicinity of centers of the two semicircular plates, and the filling tank is rotatably mounted in the liquid tank by the rotating shafts being brought into engagement with the liquid tank.

9. A beads model producing board as set forth in claim 7, wherein
the filling tank has a self-supporting projection which is provided in the vicinity of a central portion of the arc-shaped face plate so as to constitute a stand for the filling tank when the filling tank is refilled with liquid.

10. A beads model producing board as set forth in claim 8, wherein
the filling tank has a self-supporting projection which is provided in the vicinity of a central portion of the arc-shaped face plate so as to constitute a stand for the filling tank when the filling tank is refilled with liquid.

11. A beads model producing board as set forth in claim 7, wherein
a plurality of straightening vanes are formed inside the filling tank so as to straighten a flow of liquid when liquid within the filling tank is caused to flow into the liquid tank, and wherein
the plurality of straightening vanes are provided to be erected from the arc-shaped face plate so as to be parallel to a straight line which connects a center of the arc-shaped face plate and centers of the arcs and vertical to the two substantially semicircular plates and each have a U-shaped cutout in an upper end member portion thereof, at least one of the plurality of straightening vanes constituting an indicator of the amount of liquid poured in the filling tank when the filling tank is refilled with liquid.

12. A beads model producing board as set forth in claim 8, wherein
a plurality of straightening vanes are formed inside the filling tank so as to straighten a flow of liquid when liquid within the filling tank is caused to flow into the liquid tank, and wherein the plurality of straightening vanes are provided to be erected from the arc-shaped face plate so as to be parallel to a straight line which connects a center of the arc-shaped face plate and centers of the arcs and vertical to the two substantially semicircular plates and each have a U-shaped cutout in an upper end member portion thereof, at least one of the plurality of straightening vanes constituting an indicator of the amount of liquid poured in the filling tank when the filling tank is refilled with liquid.

13. A beads model producing board as set forth in claim 3, wherein
the base board member comprises the liquid reservoir portion which is depressed into a substantially rectangular shape and a tank disposing portion which is situated behind the liquid reservoir portion and where the liquid tank is disposed and includes bearing portions which each have two grooves of a front groove and a rear groove which hold rotatably the beads placing plate holding device, the bearing portions being formed on left and right side walls which make up the liquid reservoir portion and the tank disposing portion in left and right symmetrical positions which lie in the vicinity of front ends of the left and right side walls, and wherein
the beads placing plate holding device comprises a front wall, left and right side walls and a lower plate and includes engagement portions which each have two projections of a front shaft and a rear shaft which are brought into engagement with the front groove and the rear groove of the base board member, respectively, the engagement portions being formed on the left and right side walls in left and right symmetrical positions which lie in the vicinity of front ends of the left and right side walls, whereby
the beads placing plate holding device is put in a state in which the beads placing plate holding device is disposed flat in the liquid reservoir portion in the base board member by disposing the lower plate close to a bottom portion of the liquid reservoir portion from thereabove, while the beads placing plate holding device is put in a state in which the beads placing plate holding device stands on the base board member in a self-supporting fashion by inserting the front shaft and the rear shaft into the front groove.

14. A beads model producing board as set forth in claim 4, wherein
the base board member comprises the liquid reservoir portion which is depressed into a substantially rectangular shape and a tank disposing portion which is situated behind the liquid reservoir portion and where the liquid tank is disposed and includes bearing portions which each have two grooves of a front groove and a rear groove which hold rotatably the beads placing plate holding device, the bearing portions being formed on left and right side walls which make up the liquid reservoir portion and the tank disposing portion in left and right symmetrical positions which lie in the vicinity of front ends of the left and right side walls, and wherein
the beads placing plate holding device comprises a front wall, left and right side walls and a lower plate and includes engagement portions which each have two projections of a front shaft and a rear shaft which are brought into engagement with the front groove and the rear groove of the base board member, respectively, the engagement portions being formed on the left and right side walls in left and right symmetrical positions which lie in the vicinity of front ends of the left and right side walls, whereby
the beads placing plate holding device is put in a state in which the beads placing plate holding device is disposed flat in the liquid reservoir portion in the base board member by disposing the lower plate close to a bottom portion of the liquid reservoir portion from thereabove, while the beads placing plate holding device is put in a state in which the beads placing plate holding device stands on the base board member in a self-supporting fashion by inserting the front shaft and the rear shaft into the front groove.

15. A beads model producing boards as set forth in claim 7, wherein
the base board member comprises the liquid reservoir portion which is depressed into a substantially rectangular shape and a tank disposing portion which is situated behind the liquid reservoir portion and where the liquid tank is disposed and includes bearing portions which each have two grooves of a front groove and a rear groove which hold rotatably the beads placing plate holding device, the bearing portions being formed on left and right side walls which make up the liquid reservoir portion and the tank disposing portion in left and right symmetrical positions which lie in the vicinity of front ends of the left and right side walls, and wherein
the beads placing plate holding device comprises a front wall, left and right side walls and a lower plate and includes engagement portions which each have two projections of a front shaft and a rear shaft which are brought into engagement with the front groove and the rear groove of the base board member, respectively, the engagement portions being formed on the left and right side walls in left and right symmetrical positions which lie in the vicinity of front ends of the left and right side walls, whereby
the beads placing plate holding device is put in a state in which the beads placing plate holding device is disposed flat in the liquid reservoir portion in the base board member by disposing the lower plate close to a bottom portion of the liquid reservoir portion from thereabove, while the beads placing plate holding device is put in a state in which the beads placing plate holding device stands on the base board member in a self-supporting fashion by inserting the front shaft and the rear shaft into the front groove.

16. A beads model producing board as set forth in claim 13, wherein
the front grooves of the base board member are a groove which rises vertically from a lower portion of the base board member, wherein
the rear grooves of the base board member are a groove comprising an arc portion which extends downwardly rearwards from the vicinity of an upper end of the front groove and a vertical portion which rises vertically from a lower portion of the base board member at the rear of the arc portion, and wherein
a center of a radius of curvature of the arc portion of the rear groove is situated further upwards than a lower end of the front groove.

17. A beads model producing board as set forth in claim 14, wherein
the front grooves of the base board member are a groove which rises vertically from a lower portion of the base board member, wherein
the rear grooves of the base board member are a groove comprising an arc portion which extends downwardly rearwards from the vicinity of an upper end of the front groove and a vertical portion which rises vertically from a lower portion of the base board member at the rear of the arc portion, and wherein
a center of a radius of curvature of the arc portion of the rear groove is situated further upwards than a lower end of the front groove.

18. A beads model producing board as set forth in claim 15, wherein
the front grooves of the base board member are a groove which rises vertically from a lower portion of the base board member, wherein
the rear grooves of the base board member are a groove comprising an arc portion which extends downwardly rearwards from the vicinity of an upper end of the front groove and a vertical portion which rises vertically from a lower portion of the base board member at the rear of the arc portion, and wherein
a center of a radius of curvature of the arc portion of the rear groove is situated further upwards than a lower end of the front groove.

19. A beads model producing board as set forth in claim 3, wherein
the base board member, the beads placing plate and the beads placing plate holding device are all formed of a resin having light transmitting characteristics.

20. A beads model producing board as set forth in claim 4, wherein
the base board member, the beads placing plate and the beads placing plate holding device are all formed of a resin having light transmitting characteristics.

21. A beads model producing board as set forth in claim 7, wherein
the base board member, the beads placing plate and the beads placing plate holding device are all formed of a resin having light transmitting characteristics.

22. A beads model producing board as set forth in claim 16, wherein
the base board member, the beads placing plate and the beads placing plate holding device are all formed of a resin having light transmitting characteristics.

23. A beads model producing board as set forth in claim 1, further comprising:
a sample picture placing plate on which a sample picture which constitutes a sample of a beads model to be produced is placed and which can be inserted into a lower portion of the base board member.

24. A beads model producing board as set forth in claim 4, further comprising:
a sample picture placing plate on which a sample picture which constitutes a sample of a beads model to be produced is placed and which can be inserted into a lower portion of the base board member.

25. A beads model producing board as set forth in claim 13, further comprising:
a sample picture placing plate on which a sample picture which constitutes a sample of a beads model to be produced is placed and which can be inserted into a lower portion of the base board member.
